(19) United States
(12) Patent Application Publication
(10) Pub. No.: US 2003/0069930 A1
(43) Pub. Date: Apr. 10, 2003

(54) Service information multicasting method and system

(76) Inventor: Engelbertus Van Willigen, Hilversum (NL)

Correspondence Address: U.S. Philips Corporation, 580 White Plains Road, Tarrytown, NY, 10591, US

(21) Appl. No.: 10/264,905

(22) Filed: Oct. 4, 2002

(30) Foreign Application Priority Data
Oct. 9, 2001 (EP) 01203807.1

(51) Int. Cl. G06F 15/16

(52) U.S. Cl. 709/204

(57) ABSTRACT

A system (100) comprising a server (101) arranged to transmit an announcement of a multicast service to a client (103-105), the announcement comprising a structured information document. Also a method of announcing a multicast service, comprising transmitting an announcement comprising a structured information document.

When distributing data over IP networks, normally every client establishes a separate data connection with a server. So if two clients want access to the same data, the data is transmitted twice. This is not very efficient, especially in the case that large amounts of data such as audio or video streams are transmitted. To overcome this problem the concept of multicasting has been introduced.

Using multicasting a single data stream containing e.g. multimedia data like audio and/or video is transmitted over a packet-based network like an IP-based network, where it can be picked up by multiple clients that are part of a so-called multicasting group for the multicasted data stream. To find out which multicast data streams, or generally speaking which multicast sessions are available, a dedicated multicast conveying the available multicast services, such as the Session Announcement Protocol (SAP) as described in Internet RFC 2974, can be used.

A dedicated multicast server, in case of SAP called an Announcer, periodically multicasts one or more announcements identifying sessions on the local network from a well-known server name and port number. Any clients on the network can listen to the multicasted announcements and extract information on the sessions. The clients can then access the appropriate multicasting group and pick up the multicasted sessions themselves.

The information on the available multicast sessions is preferably contained in an SAP announcement formatted in accordance with the Session Description Protocol (RFC 2327). SDP is intended for describing multimedia sessions for the purposes of session announcement, session invitation, and other forms of multimedia session initiation. An example SDP description is:

v=0

o=example 2890844526 2890842807 IN IP4 126.16.64.4

s=SDP Seminar

i=A Seminar on the session description protocol

u=http://www.example.com/seminar.mpeg

e=postmaster@example.com

c=IN IP4 224.2.17.12/127

When a client receives a SAP announcement, it extracts the descriptive information and presents it to the user. However, as can be seen in the above example, an SDP description is quite limited and only contains a simple description of the source and media in question. This means that SDP cnnot be used for more advanced applications that also require the transfer of page layout information, images, data, programs, scripts and so on, e.g. for use with an Electronic Program Guide (EPG) or other functionality on the client. Further, an SDP parser must be installed in the client to extract the descriptive information, and a formatting/styling module must be installed to present the information to the user. This makes the client device more complex.

It is an object of the invention to enable multicast announcements with more possibilities for conveying information to a client.

This object is achieved according to the invention in a system comprising a server arranged to transmit an announcement of an available multicast service to a client, the announcement comprising a structured information document, and in a method comprising transmitting an announcement comprising a structured information document.

By formatting the announcement, preferably as an XML document together with one or more contextual resources and/or a style sheet, before transmitting it, the service can be announced in a more flexible way. XML provides much more possibilities for formatting and styling information and conveying other information than SDP.

Furthermore, the use of XML here unifies the web-oriented approach and announcement based approach for service discovery as now both use XML. In this way the embedded World Wide Web (WWW) browser of a client can be used for accessing Web servers as well as accessing XML that is conveyed via SAP. This way, the complexity of client devices arranged for receiving and processing SAP multicast announcements can be reduced by removing the SDP-handling components.

Preferably the method further comprises partitioning the announcement into a plurality of numbered sections and transmitting the sections as respective announcements. This way the maximum size of the announcement can be increased substantially. An optional field is preferably used to embed the section's serial number.

These and other aspects of the invention will be apparent from and elucidated with reference to the embodiments shown in the drawing, in which:

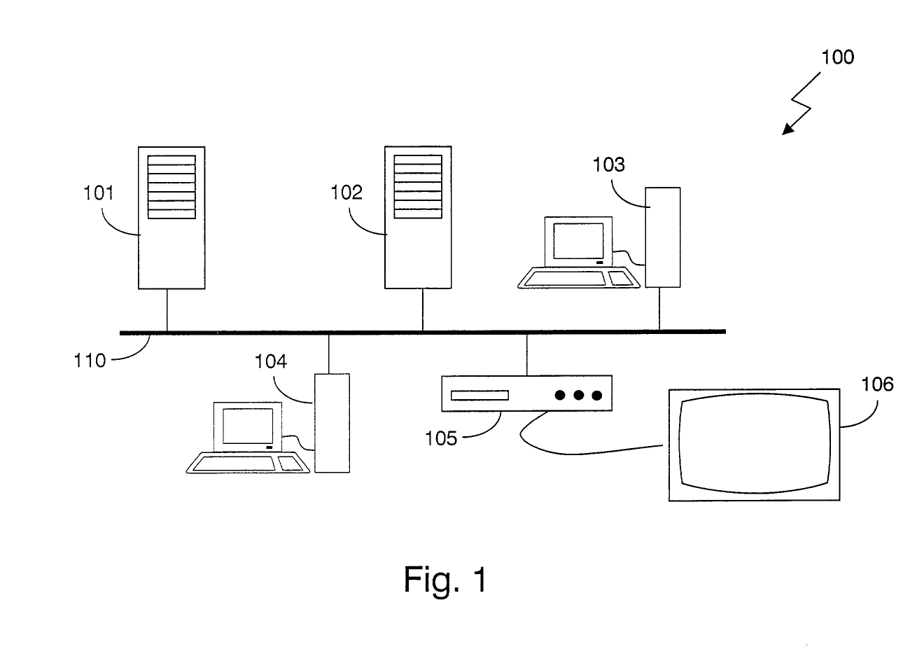

FIG. 1 schematically shows a system comprising servers and clients.

Throughout the Figures, same reference numerals indicate similar or corresponding features. Some of the features indicated in the drawing are typically implemented in software, and as such represent software entities, such as software modules or objects.

FIG. 1 schematically shows a system 100 comprising servers 101, 102 and clients 103, 104 and 105. Clients 103 and 104 are in this embodiment personal computers, and client 105 is a set-top box connected to a television 106. The devices 101-105 are interconnected via a bus 110, for example an Ethernet network or an IEEE 1394 network. The bus 110 may be connected to a larger network such as the Internet using a router (not shown). The devices 101-105 communicate with each other over the bus 110 using the Internet Protocol (IP).

In this system 100 the server 102 offers a multicast service to the other devices connected to the bus 110. This multicast service could be for instance a data stream such as an audio or video multicast, but could also be a printing service to a printer (not shown) connected to the server 102. To announce the availability of the multicast service, the server 101 operates a SAP announcing service on a well-known port, usually port 9875. The clients 103-105 listen to this port to find out which multicast services are available. The announcements broadcasted or multicasted on this port are used by the clients 103-105 to extract the information regarding the available multicast services, which information is then presented e.g. on the display screen of the personal computers 103, 104 or on the television 106. The users of the respective devices 103-105 can then select a multicast service, upon which the devices 103-105 access the multicast service in question.

Television receivers, set-top boxes and similar systems often comprise an Electronic Program Guide (EPG) which is capable of receiving and decoding data such as a program title or program category, related to programs and other content items which will be transmitted in the near future. Generally, such an EPG shows a list of program titles and the clock-times, indicating at which time and through which channel the programs will be transmitted.

Outside the context of television programs, an EPG is sometimes also referred to as an Electronic Content Guide (ECG). An ECG provides an overview of available content from one or more sources, which could be television programs, but also multicasted audio and/or video streams, Webpages and other resources. Next to listings of available content, the ECG can also provide more information on specific content items, e.g. when the user presses an ‘info’ button.

The SAP announcements contain XML pages for use in such an ECG. A WWW browser running on the clients 103-105 which implements the ECG can display the XML pages to the user. Such a page could for instance contain detailed information on the multicast service, or provide basic information that can be displayed in an overview of available content. By using XML it becomes possible to embed hyperlinks in the information, so that a user can select a service by activating the hyperlink, or access another document with additional information. The XML pages can be formatted in accordance with a Document Type Definition (DTD) or a Schema. The pages could also comprise an XML-based information structure such as the Simple Object Access Protocol (SOAP).

To enhance the information contained in the XML pages, it is often desirable to include subsidiary resources such as images, video clips, audio clips, scripts, style sheets, other HTML or XML documents, and so on. The subsidiary resources are referenced in a root resource. An XML document, for example, may reference one or more inline images to be displayed as part of the document. It may also reference a script in for instance the Javascript language that is to be executed as part of the presentation of the XML document. The root resource might also be a frameset document (see the section on frames in the HTML 4.01 Recommendation, available on the Internet at http://www.w3.org/TR/htm14/), referencing other HTML documents to be displayed in individual frames.

While it is possible to include references such as hyperlinks to subsidiary resources in the root resource, so that a browser can follow the hyperlinks and thereby access the referenced information, this means extra overhead and potentially large delays before the complete resource can be rendered.

To overcome this problem, a root resource and its subsidiary resources are preferably aggregated into a single document. This aggregate document can then be included in the SAP announcement, so that a client can directly acess all the necessary resources. A preferred mechanism to aggregate these resources is to use MIME encapsulation of aggregate documents (see RFC 2557).

An example of such a composite message structure, using the MIME multipart/related content type as defined in RFC 2387, is given below.

(1) Content-Type: multipart/related; boundary=“boundary-example”; type=“text/html”

(2) boundary-example

(3) Content-Type: text/html; charset=“US-ASCII”

(4) . . . . . . <MG SRC=“fiction1/fiction2”> . . . . . .

(5) . . . . . . <IMG SRC=“cid:97116092811xyz@foo.bar.net”> . . . . . .

(6) —boundary-example

(7) Content-Type: image/gif

(8) Content-ID: <97116092511xyz@foo.bar.net>

(9) Content-Location: fiction1/fiction2

(10) —boundary-example

(11) Content-Type: image/gif

(12) Content-ID: <97116092811xyz@foo.bar.net>

(13) . . .

(14) —boundary-example—

This example contains a root resource (lines 3-5) and two subsidiary resources (lines 7-9 and 11-13, respectively). The root resource in this example is an HTML document, although it could equally well be an XML document. The root resource contains two references (lines 4 and 5) to images that are to be displayed in-line when rendering the HTML document. These images are included as the two subsidiary resources.

The example also illustrates two ways of referencing the subsidiary resources. At line 4 the relative URL “fiction1/fiction2” is used as a reference. This relative URL is also present at line 9. This makes it possible to retrieve this subsidiary resource from the Internet by resolving this relative URL. A full URL could also be used instead. The second subsidiary resource is referenced at line 5 by its CID (RFC 2387). This CID, or Content-ID, can also be found at line 12, with the actual image data on line 13, represented as dots. This way the CID is used to reference a resource within the same composite document.

The composite message as a whole can now be included in a SAP announcement, which can be transmitted over the bus 110. The clients 103-105 that receive the announcement can extract the composite message and recover the individual root resource and subsidiary resources contained therein. The root resource can then be rendered together with the subsidiary resources used as appropriate. This way an SAP announcement can be provided in a very flexible way, since the full power of XML is now available to mark up the multicast service information. Additionally, any number of subsidiary resources can be supplied to enhance the presentation of the information.

The information contained in the aggregate resource can serve a variety of purposes. The root resource contains the necessary information regarding the announced multicast service. By using XML, this information can be provided in a structured way. Style sheets, in languages such as Cascading Style Sheets (CSS) or DSSSL, can be provided to enable the rendering of the root resource on a client.

If the structure of the information is standardized, e.g. by using a standard Document Type Definition, then the client(s) can extract the information they need from the root resource. This makes it possible to e.g. extract only the title and provider name of a particular multicast service from the announcement, so that a quick overview of offered services can be generated. The aggregate resource could comprise a XML document with the basic information in a structured way, and one or more style sheets that can transform the XML document to one or more documents suitable for presentation. This makes it possible to extract the basic information, or to present the transformed document(s), or both.

As could be seen in the above example, it is sometimes desirable to not explicitly embed the content of a subsidiary resource in the composite message. Rather, a reference to the subsidiary resource, e.g. its Internet URL, is included so that the client can retrieve it if necessary. This way bandwidth is saved. It is also possible to restrict access to the subsidiary resource in question this way. The clients are now forced to retrieve the resource from a server using the URL, and the server can consequently enforce access restrictions against certain clients.

A new URL scheme called ‘sap’ is introduced to support referencing resources within other SAP messages. This new URL scheme has the following format:

sap:[<Port>]//<Multicast Stream>/<Cid-url>

The field ‘<Multicast Stream>’ contains either the fully qualified domain name, or the IP multicast address of the SAP message in question. The field ‘<Port>’ contains the port number that is used by the SAP message. The field ‘<Cid-url>’ contains the CID URL (see RFC 2387) for referencing the resource within the SAP content.

For example, the URL: ‘sap:33678//dvbip.philips.com/foo4@foo1@bar.net’ references the resource with MIME Content-ID: ‘foo4@foo1@bar.net’ in a SAP message from the domain: ‘dvbip.philips.com’ on port number: 33678. A SAP aware browser can use these SAP URLs to ‘get’ a resource from another SAP message.

A special case is formed by MPEG-2 and -4 transport streams. To support the localization of DVB over IP services, it is desirable to have URL schemes that allow addressing of MPEG transport streams, for example as follows:

mpegts2: This URL scheme is used to designate MPEG-2 encoded video and/or audio encapsulated in MPEG-2 Transport Stream over RTP (RFC 2250). It takes the following form: mpegts2://<Multicast Stream>:<Port>

mpegts4: This URL scheme is used to designate MPEG-4 encoded video and/or audio encapsulated in MPEG-2 Transport Stream over RTP (RFC 2250). It takes the following form: mpegts4://<Multicast Stream>:<Port>

The field ‘<Multicast Stream>’ contains either the fully qualified domain name, or the IP multicast address of the MPEG service. The field ‘<Port>’ contains the port number that is used by the multicast. The encapsulated MPEG-2 transport stream contains MPEG PSI information, so that the client is able to find the MPEG program streams within the multicast.

By providing these new URL schemes, it becomes possible to reference MPEG transport streams, and to reference root or subsidiary resources present in other SAP announcements. Multiple SAP messages can now be used to convey the service information. The SAP messages can reference each other via ‘sap’ URLs. In this way resources within other SAP messages using different multicast addresses and/or port numbers, and resources on web servers can be addressed.

A SAP message containing a payload as described above, can potentially become very large. Since the payload field of a SAP message may be restricted in length, an additional measure is then necessary to still facilitate large payloads. Note that the problem of exceeding the maximum permitted length of a payload field only now becomes apparent, since traditionally the Session Description Protocol (SDP) was used to include service information. Messages in SDP format are generally much smaller than composite documents containing XML documents and images, sounds, video and so on. Of course compression can be used to reduce the size of SAP messages, but this might not always be sufficient.

A mechanism is introduced that allows the maximum size of the SAP content to be more than 65 Mbytes by partitioning the SAP content into up to 65.536 sections before it is mapped into the SAP packets. Each section is numbered and carries a part of the overall SAP content. This partitioning is also desirable to minimize data loss in error conditions. That is, a SAP packet loss is localized to a specific section of the SAP content, thus allowing other sections still to be received. Furthermore, at start-up the client can start receiving SAP sections without having seen the first section.

The mechanism, which is backwards compatible with SAP version 2 (RFC 2974), introduces two new fields in the optional Authentication Data field of the SAP message: Section Number and Last Section Number. Section Number is a 16-bit field that gives the number of this section. The first section has section number zero. This number is incremented by 1 with each additional SAP section. Last Section Number is a 16-bit field that specifies the number of the last section (that is, the section with the highest section number) of the complete SAP content.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A system comprising a server arranged to transmit an announcement of an available multicast service to a client, the announcement comprising a structured information document.

2. The system of claim 1, the announcement comprising an aggregate structure containing at least one of a textual element, an image, a video element and audio element.

3. The system of claim 2, the textual element being formatted as an XML document.

4. The system of claim 1, comprising transmitting the announcement by multicast.

5. A method of announcing a multicast service, comprising transmitting an announcement comprising a structured information document.

6. The method of claim 5, the announcement comprising an aggregate structure containing at least one of a textual element, an image, a video element and audio element.

7. The method of claim 5, comprising partitioning the announcement into a plurality of numbered sections and transmitting the sections as respective announcements.

8. The method of claim 7, comprising embedding a section's number in an optional field of the corresponding announcement.
